(19) United States
(12) Patent Application Publication
(10) Pub. No.: US 2011/0099621 A1
(43) Pub. Date: Apr. 28, 2011

(54) Process for monitoring, filtering and caching internet connections

(76) Inventors: Nicholas Lizarraga, Glendale, CA (US); Patrick Ryan, Concord, CA (US); Carl Boyd, Livermore, CA (US); Chris Taylor, Modesto, CA (US)

(21) Appl. No.: 10/421,673

(22) Filed: Apr. 22, 2003

Related U.S. Application Data
(60) Provisional application No. 60/374,973, filed on Apr. 22, 2002.

(51) Int. Cl. G06F 21/00

(52) U.S. Cl. 726/13

(57) ABSTRACT

A one-box system and process for controlling Internet usage by users on a network. The system controls usage by combining two or more of the following functions into a single operating unit: 1) monitoring and logging internet access on a user and/or work station basis; 2) preventing or authorizing access on a user and/or work station basis to ULR's (or groups of URL's) that have been previously designated an inappropriate or appropriate, respectively, for that user or work station; 3) preventing or authorizing the downloading of files with any pre-designated file extension to any user or workstation; 4) blocking of peer-to-peer access of any pre-designated Internet file-sharing or other service (such as Kazaa, RealPlayer, AOL Instant Messaging, etc); 5) periodically or immediately alerting a designated representative of the attempt by any user or work station to access of pre-determined inappropriate site or file; 6) allowing remote review of the Internet activity log for any user by anyone (such as a student's parents) with knowledge of that user's log-in information (i.e., name and password); and 7) caching downloaded Internet objects for subsequent in-network retrieval. The system and process of this invention can also be configured to perform the traditional firewall function as well.

### REFERENCE TO RELATED APPLICATION

This is a continuation-in-part of provisional patent application entitled PROCESS FOR MONITORING, FILTERING AND CACHING INTERNET CONNECTIONS, filed Apr. 22, 2002, Ser. No. 60/374,973, applicants Nicholas Lizarraga, Patrick Ryan, Carl Boyd and Chris Taylor, to be abandoned.

### BACKGROUND OF THE INVENTION

The present invention generally relates to network communications, such as communication between users on a local network and the Internet. More particularly, the present invention relates to a process of controlling such usage by selectively monitoring, filtering, caching, reporting and collecting data generated from tracking user internet activity on a network.

Internet access has always had its positive and negative sides. The ability for people, business, and educational institutions to communicate instantly with one another has to be seen as somewhat of a revolution in human development. People can instantly share information, send files, and communicate as never before. This access has its drawbacks, however. Whenever people are able to communicate on such a global scale as they are able to over the Internet, they will also share information that is considered inappropriate either due to content or due to unauthorized copying or transmission of copyrighted subject matter, for example. The explosion of the Internet in recent years has also created an explosion in the production of online pornography as well as other information that is neither work related or with much merit. It has been well documented how much time, productivity, and costly bandwidth has been wasted by institutions both educational and corporate due to such usage of the school's or institution's computer and network capabilities for such inappropriate purposes.

With the explosion in technologies of the Internet has come a surge in products promising to control the flow of inappropriate information. Unfortunately, many of the solutions offered by various hardware and software manufacturers to date have had a negative impact on the legitimate transfer and sharing of information. All of the solutions currently available are designed to block access to certain Internet sites and restrict viewing of sites that are considered “questionable” by the manufacturers of these solutions. Not only are the prior solutions either ineffective or border on censorship, these solutions are not cost effective nor are they easily implemented in an enterprise-wide environment. Other products available focus entirely on the “filtering” aspect of blocking Internet traffic. None focuses solely on the “monitoring” aspect. All have been designed to block a handful of Internet sites based on human or artificial intelligence review.

Other solutions available to control the flow of information have generally come as some form of software package. The software solutions require expensive hardware platforms to run properly as well as a seasoned technical professional to install them. Other solutions are also based on a per-user licensing arrangement that will cost an organization a large sum as it grows. The per-user license fees are also required to be paid annually so the reoccurring costs will burden an organization and take away funds that could be used elsewhere. The hardware-based solutions that are available come with many of the same problems that the software solutions have as well as other problems native to the platform. The available hardware solutions are limited in their ability to work in an enterprise level network and with common networking appliances. With both the hardware and software solutions currently available, critical issues such as compatibility and scalability exist enough to render them ineffective at best.

Problems with the currently-available enterprise-wide multi-vendor network platforms vary greatly from solution to solution. All have their shortcomings and all have been based on blocking access rather than monitoring access. Human nature is such that if one knows he or she is being watched, then they will curb their negative behavior. The Internet is growing exponentially. Soon, it will be nearly impossible to block all or even a majority of the websites that are deemed “inappropriate” by a handful of human reviewers. Software solutions have to be written for a variety of hardware platforms and are costly to implement. Hardware solutions have the same high cost as well as the added burden of simply being unable to work well with other network products.

Accordingly, there is a need for a solution to control Internet-accessing behavior within the modern day work force or educational institution. Such a solution must be able to work in conjunction with the many networking hardware and software components that are available to the enterprise-wide organization. The solution should be cost effective and reliable. The solution should avoid reoccurring costs. It should also provide for ease of installation, start up, and maintenance. It should also be easily modified and configurable on a user-by-user basis, and should be easily scalable so as to effectively and efficiently accommodate growth of the number of work stations and users on a given network. The present invention fulfills these needs and provides other related advantages.

### SUMMARY OF THE INVENTION

The present invention resides in its one-box solution to the multi-tasking processes involved in effective control of internet activity, including collecting data generated from tracking the users' activity on the network on both a user and work station basis, reporting that activity on a real-time basis to authorized managers, making that information also available to any one (such as the parents of a student user of a school's network to access the internet) having remote internet access and the requisite information (such as the student's user name and password), pre-designation of web-sites (i.e., URL's) and groups of web-sites, file extensions, and peer-to-peer programs that are either authorized or unauthorized on a user or work station basis, the ability to recognize user requests for such web-sites or peer-to-peer programs and transmissions including such file extensions, and allowing or denying access or connection accordingly.

The monitoring technology appliance of this invention, when integrated within a local area network that is connected to the Internet, serves these several roles and also including serving as a caching engine or transparent proxy. The invention has the ability to capture authentication information from a primary server user name database. The invention can also act as a pass-through-data gatekeeper and has the ability to export reporting information as to who, went where, when, on what computer (based on the computer's Net BIOS name) on the network in regards to sites visited on the Internet in real time as a web page which can be accessed anywhere on the Internet utilizing the IP address of the monitoring technology appliance set up by the installing party. The Internet monitoring technology appliance of the present invention also has the ability to capture web-based e-mails sent and received when the user is connected to the local area network that the monitoring technology appliance is installed on.

After the user logs into the local area network and opens a web browser to make an Internet request; the monitoring technology appliance then intercepts the request. The monitoring technology appliance operating system sees that it is a request for an Internet object and forwards the information to the cache server process. The cache server process accelerates the network by saving Internet objects requested by users accessing the Internet and saves these objects locally. If other users on the local area network request the same object, the monitoring technology appliance sends the local copy of the object instead of requesting them and downloading them from the Internet. Sending the saved or cached Internet objects from the monitoring technology appliance dramatically decreases the request time of the users requesting the Internet objects. The cache server process reads the user and computer names from the database for the IP address that made the Internet request.

The configuration of the user is then matched against the database of the monitoring technology appliance to see if any restrictions have been placed on the user making the request. After this check, another check for the URL, Uniform Resource Locator, being requested is verified. If the URL is on a block list then the user is redirected to a pre-configured page notifying him or her that the site is restricted based on the permissions of the user name and password utilized to log into the local area network. The request, whether restricted or not, is logged into another database that notes the URL requested, the user name, the time of the request based on the clock of the monitoring network appliance, the computer name, and the IP address assigned to the computer on the local area network that the user made the request from.

If no restrictions are placed on the URL or the user then the caching system process checks the local disk cache for the object that was requested. If it is found in cache, the cached copy of the monitoring technology appliance is used and transferred to the user. If not, the cache server process makes a request to the Internet for the requested object. The monitoring technology appliance creates a connection to the Internet, requesting the object needed. The web-site returns the object to the monitoring technology appliance. The monitoring technology appliance then forwards the information on to the cache server process. The cache server process makes a local copy of the object for future use. The cache server process then forwards the object back to the user.

To view the information that the monitoring technology appliance has gathered, an authorized individual opens a SSL secured web page and directs the page to the IP address of the monitoring technology appliance assigned by the organization when first installed. The authorized user must type a user name and password that is forwarded to the web server process. The web server process uses the authenticated manager's user name to determine what level of access the manager has to the system. The level of security will determine whose web traffic he or she will have access to. These pages are presented in HTML format and can be viewed in any current web browser.

Control over configuring and maintenance of the system and appliance is also all done via web pages.

The device of this invention can also be adapted to include conventional firewall capabilities for network protection.

Other features and advantages of the present invention will become apparent from the following more detailed description taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a schematic illustration of a monitoring and caching integrated within a local area network connected to the Internet through an Internet switch and running in Web cache coordination protocol (WCCP);

FIG. 2 is a schematic illustration of the monitoring and caching apparatus in the local area network and running in a transparent bridging mode;

FIG. 3 is a block diagram illustrating the interaction of various components utilized in the present invention;

FIG. 4 is a flow chart illustrating the process of users logging onto the area network and tracked by the present invention;

FIG. 5 is a flow chart illustrating the process of handling the interception of Web requests and caching abilities while running WCCP mode;

FIG. 6 is a flow chart illustrating the process of handling the interception of Web requests and caching abilities while running in transparent bridging mode;

FIG. 7 is flow chart of a child process used in accordance with the present invention that controls user access and generates log files;

FIG. 8 is a flow chart illustrating the steps of a child process responsible for logging Web-based e-mail when a HTML header with cookie information is found; and

FIG. 9 is a flow chart illustrating the process for system maintenance of log files when the amount of free disk spaced is low.

FIG. 10 is a flow chart illustrating the process for peer-to-peer blocking of programs.

FIG. 11 is a flow chart illustrating an alternative process for collecting user information with an executable in-system log-in script, and also for updating firewall rules in the embodiment of this invention that includes the conventional firewall functions.

### DETAILED DESCRIPTION OF THE INVENTION

As illustrated in the accompanying drawings for purposes of illustration, the present invention resides primarily in a process of reporting and collecting data generated from tracking user activity on a network, and also from restricting access to pre-designated web-based sites and services, and preventing the downloading of files with pre-designated file extensions.

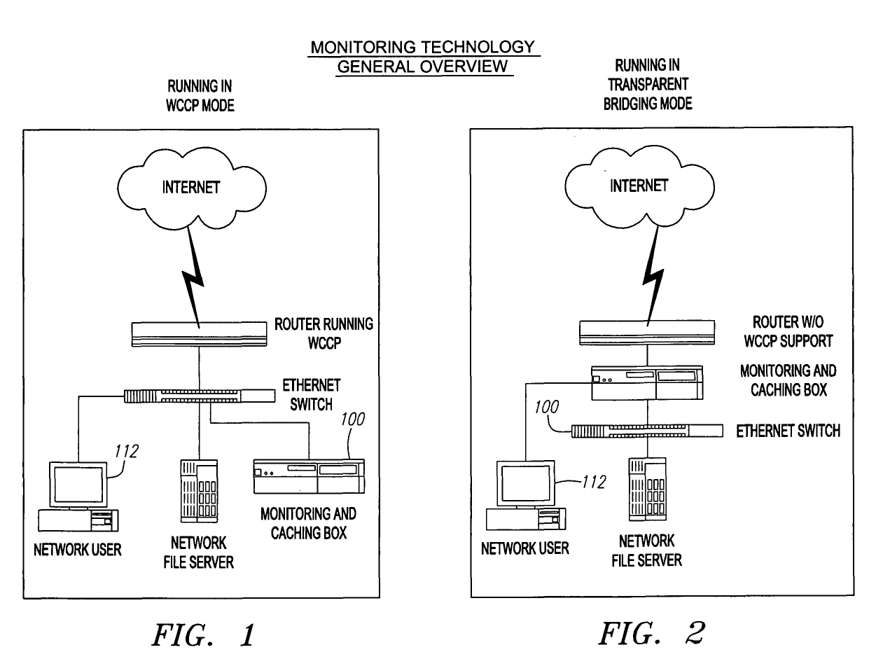

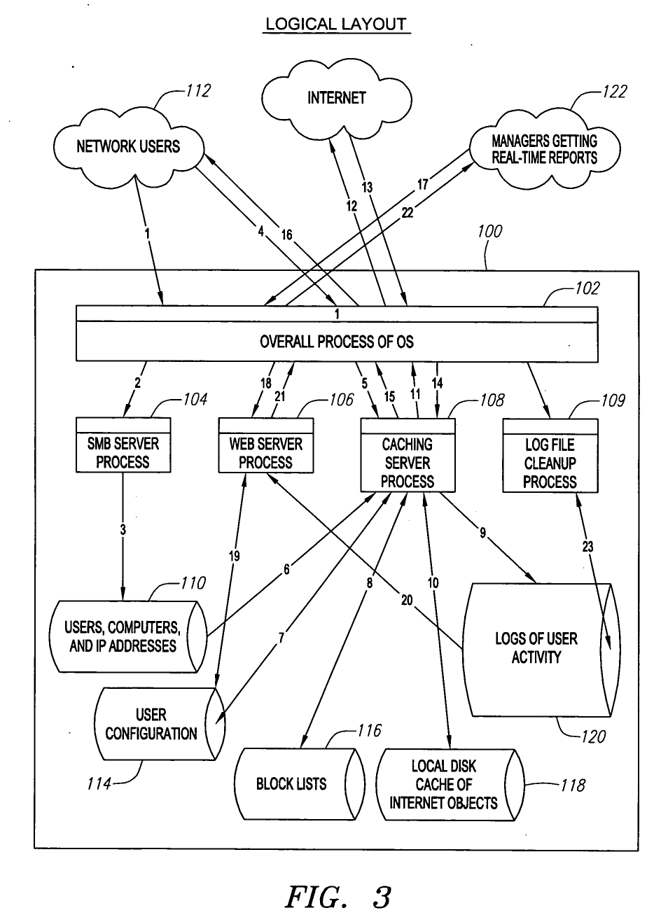

As illustrated in FIG. 1, a piece of hardware referred to as a monitoring and caching box is incorporated into the local area network in either a WCCP mode, or transparent bridging mode as illustrated in FIG. 2. FIG. 3 is a function block diagram of various databases, processes, and interconnectivity of components of the invention and users utilizing the invention.

With reference to FIG. 3, this invention is included within a single box 100, that will house the overall operating system 102 for the device, an SMB server and process 104, a web server and process 106, a caching server and process 108, a log file cleanup process 109, a database 110 that will house information and the authorized users, work stations and IP addresses on the network 112, another database 114 that will house specific user-configuration information about the authorized users on the network, another database 116 that will house the information relating to what URL's (or groups and sub-groups of them), file extensions, peer-to-peer programs and another Internet-related objects that are pre-determined to be either on the authorized or unauthorized list for each authorized user and/or work station on the network 112, another database 118 that will store locally, for a predetermined time, authorized objects that are downloaded from the internet such that subsequent requests for the same object can be filled from the local cache rather than repeatedly retrieving the same objections from the Internet; and another database 120 that will house information on a user and work stations basis regarding what user and what work station accessed, or tried to access, what URL, and when. The overall system and method of this invention will also allow authorized managers and others 122. For example, the “managers” could include a student's parent or parents, who, armed with a computer with a web browser, and the student's username and password on the school's computer network having this invention installed, could access the database of their child's internet-based activity on the school's computers, and could determine not only which sites the student visited or attempted to visit, but also from which work stations and at what time.

Again referring to FIG. 3, and specifically with reference to the numbered arrows, when a user logs on to the network they run a login script. This login script in turn runs MONITOR.EXE, which creates a temporary connection to the monitoring box (Arrow 1). The OS of the monitoring box sees a request for SMB network services and forwards the information to the SMB Server Process 104 (Arrow 2). If the resource being requested is for the logging share, the SMB Server Process updates the database of IP connections 110(Arrow 3). After logon, the user opens a web browser to make an Internet request. The Internet request is then intercepted by the monitoring OS 102(Arrow 4). The monitoring OS sees that it is a request for an Internet Object and forwards the information to the Cache Server Process 108 (Arrow 5). The Cache Server Process 108 reads the user and computer names from the database 110 for the IP address that made the Internet request (Arrow 6). Now that the monitoring OS has the user name, it checks the user configuration database 114 for any rules that might be set for this user (Arrow 7). For example, the URL that the user has requested is checked against a block list configured for this user in block list database 116. If the URL is defined as being blocked for the requesting user (or workstation), the Cache Server Process 108 flags this request as being blocked. After the logging is complete, the user will be redirected to a custom block page informing the user of their restricted access (Arrow 8). All of the information collected about the user and the Internet request is logged to the user activity database 120 (Arrow 9). If the URL requested is not blocked, then the Cache Server Process 108 checks the local disk cache 118 for the object that was requested. If it is found in cache, the cached copy is used (Arrow 10). If the requested URL is not blocked and is not in the local disk cashe 118, the Cache Server Process 108 then make a request to the Internet for the requested object which is communicated to the system OS 102 (Arrow 11). The monitoring OS creates a connection to the Internet, requesting the object needed (Arrow 12). The web site returns the object to the monitoring OS 102 (Arrow 13). The monitoring OS 102 forwards the information on to the Cache Server Process 108. The Cache Server Process 108 makes a local copy of the object for future use on to the disk cache 118 (Arrow 14). The Cache Server Process 108 then forwards the object back to the user, unless it was blocked. If so, the user is redirected to a custom block page (Arrow 15). The monitoring OS 102 forwards this back to the user that made the original request (Arrow 16).

An authorized manager 122 opens a SSL secured web page on the monitoring box (Arrow 17). The monitoring OS forwards this request to the Web Server Process 106 (Arrow 18). The Web Server Process uses the authenticated manager's user name to determine what level of access the manager has to the system. A list is then generated from the user configuration database 114 of the available users for whom that manager can access reports regarding their internet activity. (Arrow 19). After the manager selects the report on any particular user or users for which that manager is authorized to review, the Web Server Process 108 gathers the information from the user activity database 120 (Arrow 20). The Web Server Process 108 sends a real-time web based report to the manager 122 (Arrow 21), and the monitoring OS 102 forwards the web report to the manager's web browser (Arrow 22). The Log File Cleanup Process checks for the available free space on the hard disk. If the hard disk gets close to full it starts to delete the oldest log file until it reaches safe limits (Arrow 23). As will be appreciated, the “manager” could be a student's parents who from their home or office computer can log onto the network, and with their child's network user name and password, could obtain real time reports of not only what websites their child tried to access, but when and from what work station.

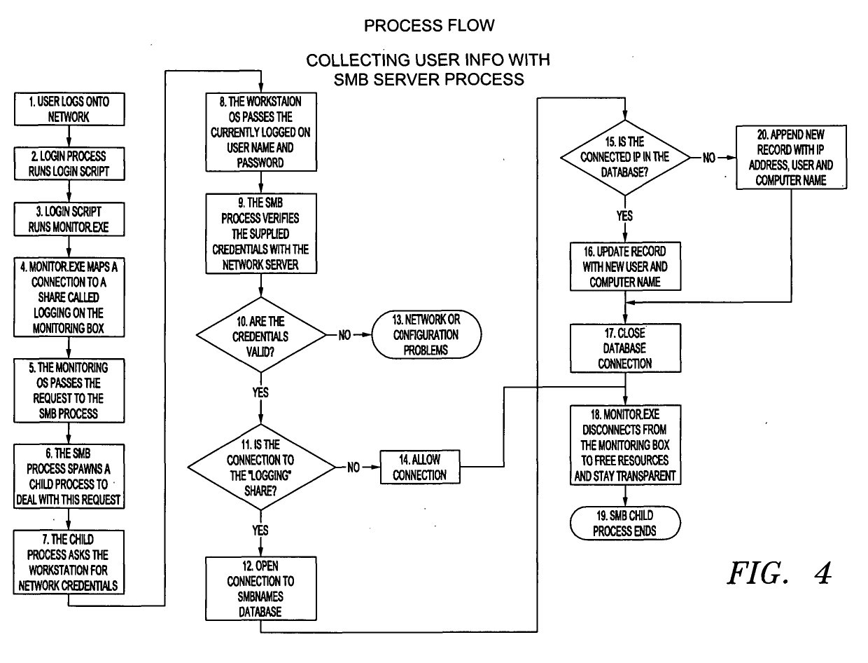

With reference now to FIG. 4, an SMB server process is illustrated used for tracking when users log onto the network and from which terminal. A user sits down at a computer and logs on to the network with a username and password (Step 1). When users log on to a network, a login script is executed. This is a script written by the network administrator that sets up the user's environment such as mapping drives and connecting to printers (Step 2). This login script would be setup to run an executable file called Monitor.EXE herein (Step 3). Monitor.EXE would open a standard SMB connection to a SMB share named ‘logging’ on the monitoring box (Step 4). The OS on the monitoring box sees the communication for a SMB resource and forwards the packets to the SMB process (Step 5). The SMB process starts a new child process to handle the request (Step 6). The child process reads the request and sends a standard SMB request back to the workstation asking for credentials (Step 7).

The workstation OS receives the standard SMB request for credentials and sends back the currently logged on user name, password, computer name, and domain name (Step 8). The SMB process receives the credentials from the workstation OS and forms a new standard authentication request to send to the network server. The SMB process then sends this request to the network server (Step 9). After the authentication request is sent to the network server, the SMB process receives an answer from the network server (Step 10).

If the supplied credentials are not valid, there are network or configuration problems. This should never occur since the user was just authenticated by the same server we just sent the same credentials to (Step 11). If the supplied credentials are valid, the SMB process checks the original request for the resource name the workstation was requesting (Step 12). If the resource-name is ‘logging’ the SMBNAMES log file is read in to memory (Step 13). If the resource being connected to is not ‘logging’, this is a normal resource request and the connection will proceed according to the standard (Step 14).

The SMBNAMES log file in memory is searched for the IP address of the workstation that the request came from (Step 15). If the IP address of the workstation making the request is in the log file, it is updated with the new user name, and computer name found is the SMB resource request (Step 16). After the SMBNAMES log file in memory is updated, it is written back out to disk (Step 17). The Monitor.EXE that was launched from the login script disconnects from the ‘logging’ resource according to the standard (Step 18). After the SMB connection is closed the child process terminates in order to free resources since it will not be needed anymore (Step 19). If the IP address of the workstation is not in the SMBNAMES log file, a new entry will be added listing the IP address, user name, and computer name found in the SMB resource request (Step 20).

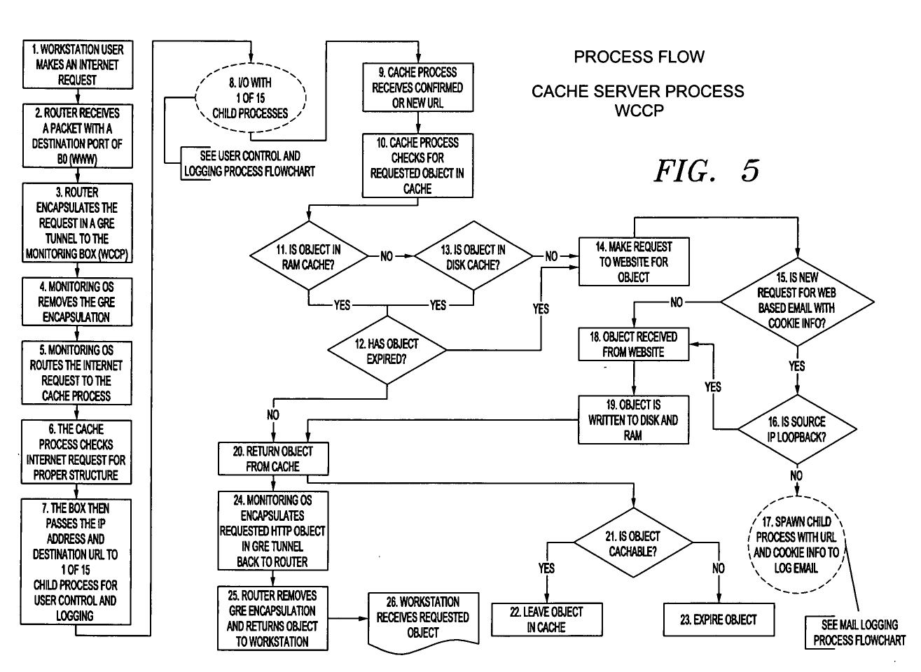

With reference now to FIG. 5, a WCCP cache server process that handles interception of Web-requests and caching abilities while running in WCCP mode is illustrated. A user at a workstation on the network opens their web browser and goes to a web site. This creates an IP packet sourced from the local workstation destined for the web site (Step 1). This IP packet is routed through the network until it reaches a router configured for WCCP, a Cisco standard. This protocol detects IP traffic destined for web sites and redirects them to a local web cache (Step 2). The router running WCCP encapsulates the IP packet in to a GRE tunnel to the monitoring box. This is all defined by the WCCP standard (Step 3). The monitoring OS receives the packet in the GRE tunnel and removes the GRE encapsulation, resulting in the original IP packet from the workstation (Step 4). The monitoring OS forwards the IP packet destined for TCP port 80 (WWW traffic) to the cache server process. (Step 5). The cache server process checks the IP packet for a properly formed Internet request (Step 6).

With a properly formed URL and the source IP address gathered from the IP packet, the IP and URL are passed through STDIO (Standard Input/Output) to 1 of 15 child processes. The child process will take the URL and source IP, log the request and either confirm the URL or return a new redirected URL (Step 7). The STDIO is handled between the cache server process and one of the ‘User Control and Logging’ child processes (Step 8). The cache server process receives the new or confirmed URL from the child process through STDIO (Step 9). The cache server process checks for the URL object in the cache (Step 10). There are two caches. The RAM cache is full of objects that have been recently used. The disk cache is objects that have been flushed from RAM and written to disk for later use. A check is performed to find out whether the object is in RAM or not (Step 11). Once the object has been found in cache, it is checked for expiration. This is performed according to the Internet caching standards (Step 12).

If the object is not found in the RAM cache, the disk cache is checked. (Step 13). If the object is not fount in either cache, a TCP connection is made to the hosting website for the object. This is the original request made by the workstation (Step 14).

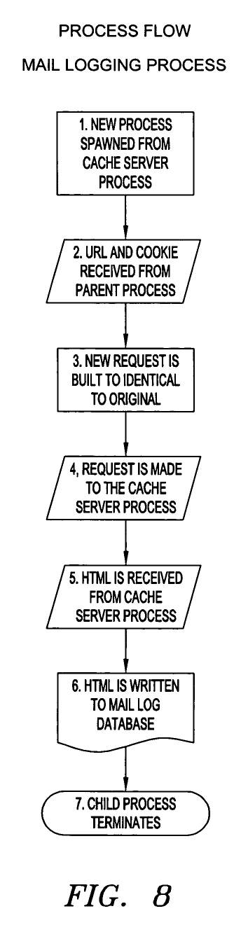

The Internet request contains header information. This header information is checked for cookie info used by web based e-mail servers. (Step 15). If the header did contain cookie info, the source IP is checked to see if it came from the loop back address (Step 16). If the source IP is not the look back address, the URL and cookie are used in spawning a child process to capture web-based email. The child process is described in FIG. 8. (Step 17). The object is received from the website that the new request referenced (Step 18). This object is written to both the disk and RAM caches (Step 19). Now that the object requested by the workstation is in the cache, it is sent to the workstation that requested it (Step 20).

After the object has been returned to the workstation, it is checked whether it is cacheable or not. This is also performed according to the Internet caching standards (Step 21). If the object is cacheable according to the standard, it is left in cache (Step 22). If the object is not cacheable according to the standard, it is expired (Step 23).

Now with the object to return to the workstation, the object is encapsulated into another GRE tunnel back to the router running WCCP that originally sent the monitoring box the IP packet. The object is formatted to appear to have come from the web site that it requested it from, regardless of WCCP interception, and whether it came from cache or not (Step 24). The router running WCCP removes the GRE encapsulation leaving the IP packet encapsulated by the monitoring box. This IP packet is sent back to the workstation that made the original request (Step 25). The workstation receives the object requested. The object is formatted appropriately in the web browser. This is what the user sees (Step 26).

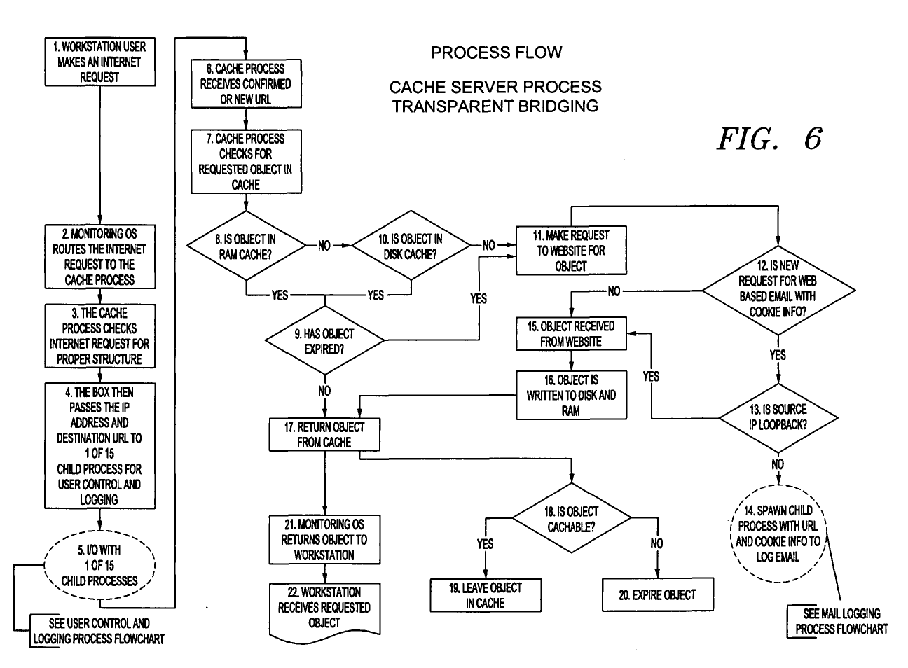

Referring now to FIG. 6, a cache server process is illustrated for handling the interception of Web requests and cacheting abilities while the invention is running in transparent bridging mode. A user at a workstation on the network opens their web browser and goes to a web site. This creates an IP packet sourced from the local workstation destined for the web site (Step 1). This IP packet is broadcast through the network until it reaches the inside NIC (Network Interface Card) of the monitoring box. The monitoring OS receives the IP packet destined for TCP port 80 (WWW traffic) and then forwards the packet to the cache server process. (Step 2). The cache server process checks the IP packet for a properly formed Internet request (Step 3).

With a properly formed URL and the source IP address gathered from the IP packet, the IP and URL are passed through STDIO (Standard Input/Output) to 1 of 15 child processes. The child process will take the URL and source IP, log the request and either confirm the URL or return a new redirected URL (Step 4). The STDIO is handled between the cache server process and one of the child processes (Step 5). The cache server process receives the new or confirmed URL from the child process through STDIO (Step 6). The cache server process checks for the URL object in the cache (Step 7). There are two caches. The RAM cache is full of objects that have been recently used. The disk cache is for objects that have been flushed from RAM and written to disk for later use. A check is performed to find out whether the object is in RAM or not (Step 8). Once the object has been found in cache, it is checked for expiration. This is performed according to the Internet caching standards (Step 9). If the object is not found in the RAM cache, the disk cache is checked (Step 10). If the object is not found in either cache, a TCP connection is made to the hosting website for the object. This is the original request made by the workstation (Step 11).

The Internet request contains header information. This header information is checked for cookie info used by web based e-mail servers. ($tep 12). If the header did contain cookie info, the source IP is checked to see if it came from the look back address (Step 13). If the source IP is not the look back address, the URL and cookie are used in spawning a child process to capture web-based email. The child process is described (Step 14).

The object is received from the website that the new request referenced (Step 15). This object is written to both the disk and RAM caches. (Step 16). Now that the object requested by the workstation is in the cache, it is sent to the workstation that requested it (Step 17).

After the object has been returned to the workstation, it is checked whether it is cacheable or not. This is also performed according to the Internet caching standards (Step 18). If the object is cacheable according to the standard, it is left in cache (Step 19). If the object is not cacheable according to the standard, it is expired (Step 20). Now with the object to return to the workstation, the object is formatted into an IP packet to appear to have come from the web site that it requested it from, regardless if it came from cache or not. This IP packet is sent back to the workstation that made the original request (Step 21). The workstation receives the object requested. The object is formatted appropriately in the web browser, and displayed to the user (Step 22).

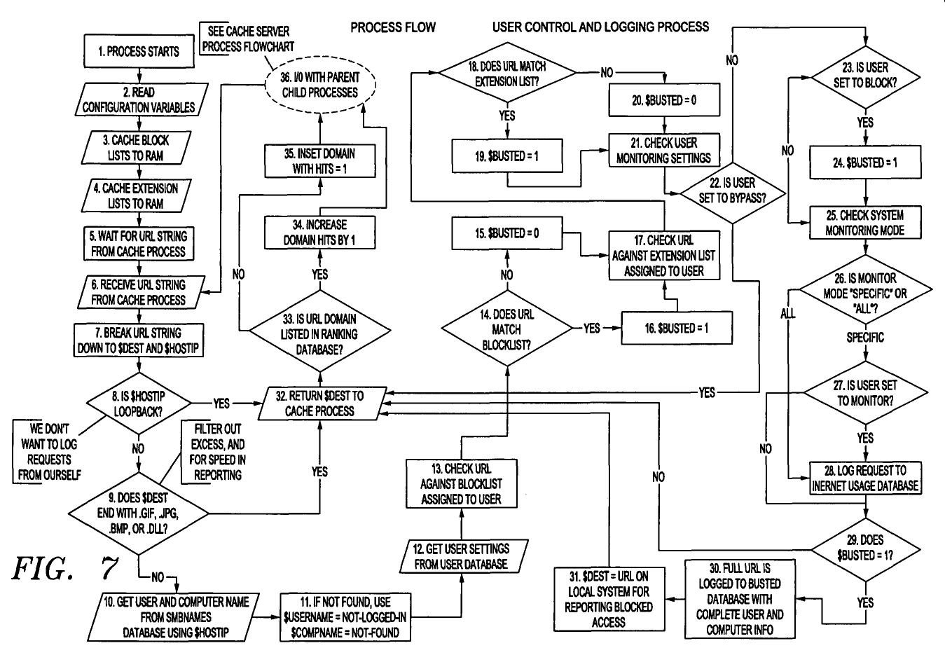

With reference now to FIG. 7, a flow chart illustrating user control logging process comprising one of the fifteen child processes that control user access and generic log files in accordance with the present invention is illustrated.

When the Cache Server Process starts it needs to start the fifteen child processes it uses for controlling user access and generating the usage logs (Step 1). When the child process starts it will read the configuration of the monitoring box in to a set of variables that will be needed later for operations that are specific to its particular configuration (Step 2). The block lists are cached to RAM for faster access when looking up URL to be blocked (Step 3). The file extensions lists are also cached to RAM for faster access when checking for block file extensions to prevent file downloading (Step 4).

At this point the child process is initialized and ready to start accepting URLs (Step 5). Through STDIO the child process receives a string of text that contains the URL and IP address space delimited (Step 6). The string of text is broken down to two variables, shown as $dest and $hostip (Step 7). The variable $hostip is check to see if the request came from the loop back address. Log requests that self-originated are not wanted (Step 8). The variable $dest is checked to see if the end of the URL ends with ‘.gif’, ‘.jpg’, ‘.bmp’, or ‘.dll’. It is desirable to filter out excess requests and keep the log files smaller. This in turn speeds up the reporting (Step 9).

If the URL doesn't end with the extensions listed in step 9, the user and computer names are looked up in the SMBNAMES log file by the IP address stored in the variable $hostip (Step 10). If a user and computer name are not found in the SMBNAMES log file, then $username=‘Not-logged-in’ and $computername=‘Not-found’ (Step 11).

Now that we have a user name we can lookup the user's settings for controlling their access. These setting are kept in variables for use later in this process (Step 12). The URL is checked against the block list that is assigned to the user (Step 13). Check for the URL in the user specific block list (Step 14). If the URL does not match any in the block list, the variable $busted is set to ‘0’ (Step 15). If the URL does match another in the block list, the variable $busted is set to ‘1’ (Step 16). The URL is checked against the extension block list that is assigned to the user (Step 17). Does the end of the URL match any of the extensions in the block list (Step 18)? If the extension does match, the variable $busted is set to ‘1’ (Step 19). If the extension does not match, the variable $busted is left set to ‘0’ (Step 20).

The user's monitoring settings are checked next (Step 21). Check whether the user is set to bypass (Step 22). If the user is not set to bypass, they are then checked if they are set to block (Step 23). If the user is set to block, the variable $busted is set to ‘1’ (Step 24). The monitoring mode, either all or specific, is the next thing to check. This controls whether to log all users or just those specified (Step 25). Check the monitor mode variable that was read in during the initialization step (step 2) for the monitoring mode. (Step 26). If monitor mode is set to specific, check the user settings to see if they are set to monitor (Step 27). If the user is set to monitor, or the system is setup to monitor all, log the URL request to the Internet usage database (Step 28).

Check the value of the $busted variable (Step 29). If the $busted variable is equal to ‘1’, log URL, user, and computer information to the busted database (Step 30). The $dest variable is changed to a URL that points to the local system for reporting back to the user that their request has been denied (Step 31). The $dest variable is now the URL that will be returned back to the cache server process (Step 32).

The ranking database is now checked for the domain of the URL that was requested (Step 33). If the domain is listed in the ranking database, the hits field is increased by 1 (Step 34). If the domain is not listed in the ranking database, it is added and the hits field is set to 1 (Step 35). The value of the $dest variable is returned back to the parent cache server process through the STDIO interface. The child process resets its variables and waits for another URL string from the parent cache server process through the STDIO interface (Step 36).

With reference now to FIG. 8, a mail login process comprising a child process of the cache server process that is responsible for logging web-based e-mail when a HTML header is found with cookie information as illustrated. This is the child process of the cache server process that is responsible for logging web-based email when a HTML header is found with cookie information in it. A new child process is spawned from the cache server process. This process is used for getting a copy of the web mail that goes through the network (Step 1). The URL and Cookie from the HTTP header is received from the parent cache server process through the STDIO interface (Step 2). A new HTTP request identical to the first is built and sent sourced from the loop back address (Step 3). This new HTTP request gets intercepted by the cache server process and handled the same way as the first (Step 4). The HTML code is returned the same way a workstation browser would receive it (Step 5). This HTML code is written to the Mail Logging database (Step 6). This child process terminates and frees up its resources to the OS (Step 7).

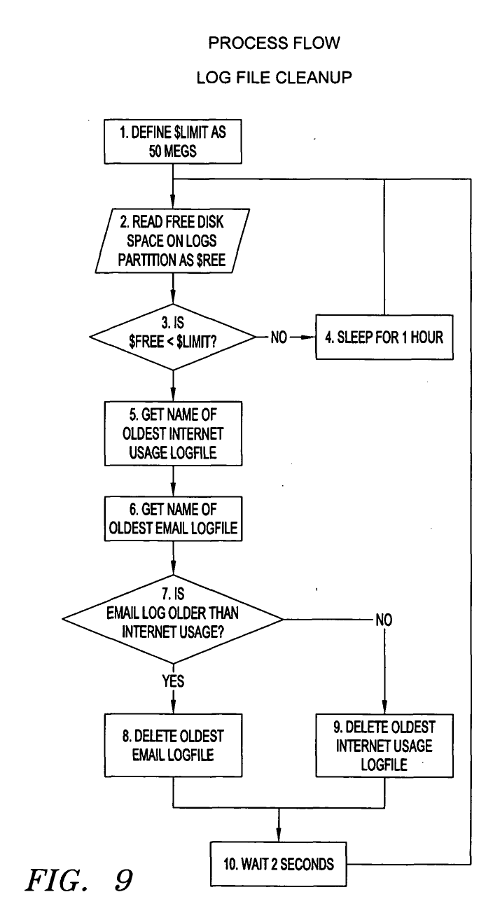

With reference now to FIG. 9, a log file clean-up process responsible for system maintenance of log files when the amount of free disk space is dangerously low is illustrated. This child process continues running the entire time the system is up and running. A variable such as the illustrated $limit is set to 50 megabytes (Step 1). The amount of free space of the log file partition on the SCSI disk is read in to a variable named, $free herein (Step 2). The variables $limit and $free are compared (Step 3). If the variable $free is not less than $limit, the process sleeps for 1 hour and then loops back to step 2 (Step 4). If the variable $free is less than $limit, then the name of the oldest Internet Usage log file will be stored in a temporary variable (Step 5). The name of the oldest mail log file will be stored in a temporary variable (Step 6). The dates of the Internet Usage log file and mail log file will be compared (Step 7). If the mail log file is older than the Internet Usage log file then the mail log file will be deleted (Step 8). If the Internet Usage log file is older than the mail log file then the Internet Usage file will be deleted (Step 9). The process will sleep for two seconds and then loop back to step 2. This keeps the process from utilizing excessive system resources, in the event the process were to experience problems (Step 10).

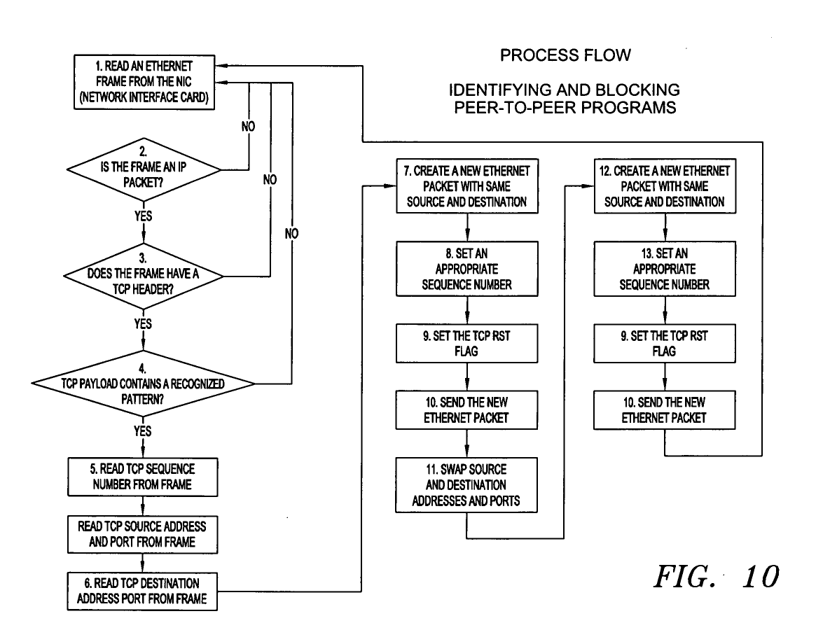

FIG. 10 displays the process flow whereby the system of this invention provides for the identification and selective blocking of peer-to-peer programs from being accessed by network users. In the preferred embodiment, the system is adapted to determine if an ethernet frame packet that is received by the network (and is received by the monitoring OS) is an Internet Protocol (IP) packet; if so, it is next determined if the packet has a Transmission Control Protocol (TCP) heading; and if so, whether the TCP payload within that packet contains any one of several predetermined TCP's and patterns that are markers for certain peer-to-peer programs that have been predetermined to be inappropriate for networks users to access. For example, the OS for the monitoring box can be set, on a user basis, to deny access to any or all of the following services: AOL Instant Messenger; Citrix ICA, Edonnkey, GTP downloads, Gnutella Network, ICQ Messenger, Internet Relay Chat, Kazaa, MSN Instant Messenger, PcAnywhere, Quicktime, RealPlayer, WinMX, etc.

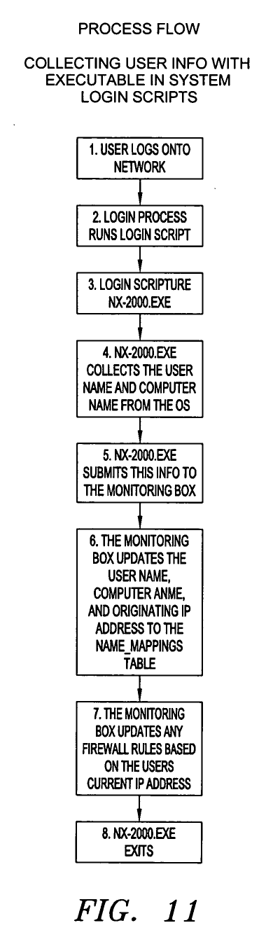

FIG. 11 displays an alternative process for collecting information on users using a different executable program NX-2000.EXE and in conjunction with the firewall function, which eliminates many of the process steps in the alternative embodiment shown in FIG. 4. In the process shown in FIG. 11, the log-in process runs the script when a user signs onto the network, which in turn runs NX-2000.EXE, which in turn collects information about the user and work station being used from the operating system for the monitoring device. The monitoring box updates its databases and the firewall rules based upon the user's current IP address, thereby tracking and applying all of the firewall and other blocking functions for that user to that IP address. The NX-2000.EXE process then exits.

Although embodiments have been described in detail for purposes of illustration, various modifications may be made without departing from the scope and spirit of the invention.

1. A one-box system for controlling Internet usage by users and work stations on a network, the system including RAM and disk storage, informational data bases, and an SMB server, a web server, and a cache server, all interconnected to a computer network of work stations having Internet access, wherein:
a) said SMB server is adapted to run a process for collecting certain identifying information about a user and the user's work station on a network when the user logs onto the network;
b) said web server is adapted to intercept a user's request for Internet access to a URL, and to forward that request to said cache server contained within the system;
c) said cache server is adapted to process the request to determine if any restrictions have been pre-placed on the requesting user's or work station's access to the requested URL; if so, the cache server process causes a pre-configured page to be delivered to the user advising the user that access was denied; or if not, the cache server process checks the local disk storage to determine if the requested object is already in cache; and if so, provides that object to the user, and if not, makes the request to the Internet for the object, and in turn causes it, once received, to be added to cache and delivered transparently to the requesting user;
d) said caching server is further adapted to cause all interne requests, restricted and unrestricted, to be logged, by requesting user, work station and URL requested, into a database that is accessible by said web server; and
e) said web server being further adapted to receive and process requests by authorized individuals from both within or without the network for access to a user's or a work station's history of Internet activity; and upon proper verification of the individual's right to receive such information, processes the request and provides such information from the database of the user's activity.

2. The system of claim 1 wherein said cache server is further adapted to receive all incoming email to users on the network; to identity file extensions for files contained therein; to compare the file extension against a predetermined list of approved and unapproved file extensions for the requesting or receiving user and/or work station contained in a database within the system; and to reject or accept the email accordingly.

3. The system of claim 1 which further includes means for identifying a peer-to-peer program which a user on the network has attempted to access; means for comparing that program to a predetermined list of approved and unapproved programs for that user or workstation, and to deny or allow access accordingly.

4. The system of claim 1 further adapted to provide firewall capabilities to restrict access to the network by unauthorized users.

5. The system of claim 1 further adapted to provide means for automatically removing the oldest internet activity information from the database containing that information when the available memory in the database reaches a predetermined minimum amount.

6. A method for controlling internet access comprising the steps of:
a) identifying information about a user and the user's work station on a network when the user logs onto the network;
b) intercepting a user's request for Internet access to a URL;
c) forwarding that request to a cache server contained within the system;
d) determining if any restrictions have been pre-placed on the requesting user's or work station's access to the requested URL; and if so, causing a pre-configured page to be delivered to the user advising the user that access was denied; or if not, checking a local disk storage to determine if the requested object is already in cache; and if so, providing that object to the user, and if not, making the request to the Internet for the object, and in turn adding it, once received, to cache and delivering it transparently to the requesting user;
f) logging all internet requests, restricted and unrestricted, by requesting user, work station and URL requested, into a local database; and
g) allowing any authorized person with internet connectivity to access the logged information on the local database.

7. The method of claim 6 further comprising the steps of receiving all incoming email to users on the network; identifying file extensions for files contained therein; comparing the file extension against a predetermined list of approved and unapproved file extensions for the requesting or receiving user and/or work station contained in a database within the system; and rejecting or accepting the email accordingly.

8. The method of claim 6 further comprising the steps of identifying a peer-to-peer program which a user on the network has attempted to access; comparing that program to a predetermined list of approved and unapproved programs for that user or workstation, and denying or allowing access accordingly.

9. The method of claim 6 further comprising the step of modifying the authorized or unauthorized URL, file extension, or peer-to-peer program on a user-by-user basis using a one-click indication by the authorized manager or managers of the system.
